(19) United States
(12) Patent Application Publication
(10) Pub. No.: US 2003/0134026 A1
(43) Pub. Date: Jul. 17, 2003

(54) Tomato paste and sauce

(75) Inventors: Nancy Sue Blaker, Sacramento, CA (US); Jinguo Hu, Davis, CA (US); Adel El-Sheikh, Woodbridge, CA (US)

Correspondence Address: UNILEVER, PATENT DEPARTMENT, 45 RIVER ROAD, EDGEWATER, NJ, 07020, US

(73) Assignee: Lipton

(21) Appl. No.: 10/213,819

(22) Filed: Aug. 7, 2002

Related U.S. Application Data
(63) Continuation of application No. 09/053,717, filed on Apr. 2, 1998, now abandoned.

(51) Int. Cl. A23L 1/238

(52) U.S. Cl. 426/589

(57) ABSTRACT

Homozygous rin and/or nor tomatoes, or tomatoes heterozygous in both rin and nor are used to prepare a tomato paste, juice or sauce having good viscosity as well as good color. Preferably the tomatoes used also include color enhancing genes such as old gold crimson (og^{c}), high pigment (hp), dark green (dg), intense pigment (Ip), or color enhancing transgenic genes.

### BACKGROUND OF THE INVENTION

Tomatoes which yield juice having high viscosity are valued for production of tomato sauces. Unfortunately, tomatoes used commercially today tend to yield juices having less than optimal viscosity. In general, as ripening of tomatoes progresses, the viscosity of resulting juices decreases. The ripening inhibitor gene (rin) is a semi-dominant gene which was first described in 1968 by Robinson and Tomes, “Ripening Inhibitor: A Gene with Multiple Effects on Ripening.” Rpt. Tomato Genetics Cooperative 18:36-37. Tissue softening and pigment synthesis which occur in normal tomato fruits are inhibited in fruits of rin tomato mutants.

Heterozygous rin tomato fruit ripen more slowly than normal fruit, are firmer and have less polygalacturonase (PG) activity than non-rin fruit. Carotenoid accumulation is delayed and somewhat reduced in the heterozygous rin fruit, as reported by Buescher, et al. 1976, “Softening, Pectolytic Activity and Storage-life of rin and nor Tomato Hybrids,” Hort Sci. 11:603-604. See also Murray et al. 1995. “Evaluation of transgenic tomato fruit with reduced polygalacturonase activity in combination with the rin mutation.” Postharvest Biology and Technol, 6:91-101.

Tomatoes having the rin gene in the heterozygous condition have been sold as fresh tomatoes and used as processing tomatoes. However, while heterozygous rin tomatoes are firmer, the viscosity of the juice prepared from heterozygous rin tomatoes is still less than optimal; although use of rin heterozygotes can result in small increases in serum viscosity and lower Bostwick thickness values in cold break processing, heterozygous rin fruit do not differ from non-rin tomatoes in Bostwick thickness or serum viscosity when processed by hot break methods.

Davies et al. 1981, “The Constituents of Tomato Fruit—The Influence of Environment, Nutrition and Gene Type,” CRC Critical Reviews in Food Science and Nutrition, 15:205-280, indicates that the deleterious effects of ripening inhibitor genes in the heterozygous state may possibly be overcome by incorporating genes which will enhance color, such as high pigment and crimson.

Old gold crimson, a color enhancing gene, was first described in 1962 (Butler, L. R. and Tomes, M. L., 1962, “Crimson, a new fruit color,” Tomato Genet. Coop. Rpt. 12:17-18) and was determined by Thompson et al. (“Characterization of crimson tomato fruit color,” 1965, Proc. Amer. Soc. Hort. Sci. 86:610-616) to be a single recessive gene.

Fruits homozygous for rin are known, but it is also known that the normal ripening processes such as chlorophyll degradation, carotenoid biosyntheses, increased respiration, increased ethylene production and PG activity are nearly inhibited. Tigchelaar et al. 1978. “Genetic Regulation of Tomato Fruit Ripening.” Hort Sci. 13:508-513, Della Penna et al. 1987. “Polygalacturonase Gene Expression in Rutger, rin, nor Nr. Tomato Fruits.” Plant Physiol. 85:502-507.” According to Tigchelaar et al., the color of mutant rin is generally unacceptable for traditional fresh or processed use (p. 512). And Buescner et al. state that since no method has been discovered which will adequately ripen rin or nor tomatoes, the mutants are presently only suitable for processed green tomato products.

Fruits heterozygous in both rin and in nor are known, e.g. from Kopelovitch et al., “The Potential of Ripening Mutants For Extending The Storage Life of the Tomato Fruit,” Euphytica 28 (1979), 99-104. They disclose that in plants heterozygous for rin and nor, softening of fruit and carotenogenesis proceed at a rate intermediate between the normal and the mutant parents.

Kopelovitch et al. produced various homozygotes and F1 heterozygotes and reported that none of the homozygous ripening mutants developed normal or even pale-red pigmentation whereas in all heterozygotes between ripening mutants and high-pigment, a red, pale red or pink color had developed when the fruits were picked ripe. Fruit of the F1 hybrid between rin and nor developed a pale red color said to be acceptable for marketing. Fruit homozygous for rin or nor showed extremely long shelf life and the F1 (rin×nor) also exhibited excellent keeping ability. Among F1 crosses with hp. the most promising was said to be the one with nor.

Tigechelaar et al., “Natural and Ethephon-Stimulated Ripening of F1 Hybrids of the Ripening Inhibitor (rin) and Non-ripening (nor) Mutants of Tomato (Lycopersicon esculentum Mill.) Aust. J. Plant Physiol., 1978, 5, 449-456, discloses ripening experiments with rin and nor hybrids.

Nahum U.S. Pat. No. 4,843,186 discloses a heterozygous tomato plant, heterozygous in rin, which is said to develop a full red color.

It is believed that tomatoes homozygous in rin and including one or more color enhancing genes are used commercially, but only to make heterozygous rin tomatoes, rather than for making paste.

### SUMMARY OF THE INVENTION

The present invention is directed to the discovery that, contrary to expectations, homozygous rin tomatoes can be successfully used to prepare an acceptable paste or a sauce, e.g., a red pasta sauce. As a result of the present invention, it is possible to take advantage of the outstanding paste and serum viscosity of tomatoes which are homozygous in the rin genes without sacrificing desirable tomato color characteristics which are of importance to consumers. Also, the paste and serum of the tomatoes enjoy excellent resistance to syneresis. It is likewise believed that homozygous nor tomatoes or heterozygous rin/nor tomatoes can be advantageously used in the present invention,

Preferably tomato pastes according to the invention have at 12 Brix Bostwick thickness values in the range of from 0-3 cm, preferably from 0-2 cm. Likewise preferred tomato pastes according to the invention enjoy at 12 Brix syneresis levels of less than 4 mm, preferably less than 3 mm. This is in contrast to Bostwick values of 4.5-7 cm and syneresis values of 13-25 mm for, e.g., the known BOS 3155 variety.

In a first aspect, the invention pertains to a paste comprising tomatoes which are homozygous in the rin and/or nor genes or heterozygous in both the rin and nor genes. The most preferred pastes include tomatoes which are homozygous in rin and/or nor. In a still more preferred additional aspect of the invention, the paste is prepared by using tomatoes which are homozygous in the rin and/or nor genes or heterozygous in both rin and nor and which in addition comprise color enhancing genes such as old gold crimson (og^{c}), high pigment (hp), dark green (dg), intense pigment (Ip), as well as color enhancing transgenic genes.

The invention makes possible tomato paste having both good color and outstanding thickness, without requiring the mixing of different types of tomatoes. Preferably USDA paste color scores at 8.5 Brix for pastes of the invention range from 35 to 50, especially greater than 42.

We have found that it is possible to produce a tomato having both homozygous rin and the old gold crimson genes, wherein the tomato color is good, yet at the same time tomato fruit firmness and juice and paste viscosity are excellent as a result of the ripening inhibiting effect of the rin gene. In addition to pastes, the invention pertains to juices and sauces made from homozygous rin and/or nor tomatoes, or from tomatoes heterozygous in rin and nor, and, preferably to pastes, juices and sauces made from tomatoes which are homozygous in rin and/or nor, or heterozygous in rin and nor, and which include color enhancing genes, as well. Preferably, the invention concerns pastes, juices and sauces made from populations or assemblages of the above fruits having an average of at least 25% by weight, and preferably at least 50%, more preferably at least 90% of the tomatoes with the above-described genes.

In addition to using homozygous rin and/or nor genes, the invention encompasses the use of tomatoes which are heterozygous in the rin gene and heterozygous in the nor gene. Also, the homozygous rin or nor genes may be combined with additional rin or nor genes, e.g. to produce a tomato which is homozygous in rin and homozygous in nor or homozygous in either rin or nor and heterozygous in the other.

The pastes of the invention preferably include at least 50% by weight of the homozygous rin and/or nor tomatoes, or of the heterozygous rin/nor tomatoes, especially from 50 to 100% by weight. The juices of the invention preferably include at least 20% by weight of the homozygous rin or nor tomatoes, especially from 20 to 40% by weight.

Preferably, the tomatoes used in the invention are homozygous in the color enhancing gene such as og^{c}, as well as the rin and/or nor gene.

Use of the homozygous rin tomatoes is particularly beneficial in view of their unique qualities, such as extremely high viscosity, almost no syneresis, high molecular weight polymers and large pectin chains. To our knowledge, these advantages are not achieved with tomatoes or tomato pastes outside of our invention. A secondary benefit is that as a result of such characteristics, less paste can be used in preparing a sauce. Similar advantageous are anticipated for homozygous nor and for heterozygous rin/nor tomatoes. The advantageous paste characteristics according to the invention can be expected to translate to improved, consumer perceivable sauce characteristics, such as improved mouthfeel and texture and to lead to a more full-bodied sauce.

For a more complete understanding of the above and other features and advantages of the invention, reference should be made to the following detailed description of preferred embodiments and to the accompanying drawings.

### BRIEF DESCRIPTION OF THE DRAWINGS

FIG. 1 is a graph of total solids vs. °Brix for the RIN (rinrin) tomato paste according to the invention and for tomato paste made from commercially available BOS 3155 tomatoes.

FIG. 2 is a graph of concentration dependencies of G′ for the RIN (rinrin) tomato paste according to the invention and for tomato paste made from commercially available BOS 3155 tomatoes.

FIG. 3 is a graph comparing °Brix with G′ for the RIN (rinrin) tomato paste according to the invention and for tomato paste made from commercially available BOS 3155 tomatoes.

FIG. 4 is a graph showing qualitatively the differences in amounts of pectic oligomers for RIN (rinrin) and Bos 3155 paste serums.

### DETAILED DESCRIPTION OF THE INVENTION

The rin gene, which is semidominate in tomato, is available from several sources, including the C. M. Rick Tomato Genetic Resource Center (TGRC) at the University of California, Davis. The rin gene is described in the literature, e.g., in Davies et al. and Tigchelaar et al., mentioned above.

Another mutant gene directed to impeding ripening is the “non-ripening” nor gene, which is recessive but has ripening and enzymatic characteristics which are very nearly identical to rin. (Buescher et al. 1976, Della Penna et al. 1987, Tigchelaar et al. 1978.) The paste characteristics of the homozygous nor gene can be expected to be nearly identical to those of the homozygous rin paste. Since the homozygous nor fruit suffers from the same color deficiencies as the homozygous rin, this gene likewise can be used in combination with a color enhancing gene in accordance with the invention.

The old gold crimson (og^{c}) color enhancing gene is readily available from several sources including the TGRC at UC, Davis, and is currently used in the tomato processing industry. This color variant was first described in 1962 (Butler and Tomes 1962) and was determined by Thompson et al. (1965) to be a single recessive gene. Fruit containing og^{c} has a redder color and higher lycopene content than normal fruit. Other color enhancing genes, e.g., those mentioned above, are available and may be used in the present invention.

Whereas the color scores of homozygous rin pastes can be expected to be very low, e.g. USDA paste color scores at 8.5 Brix of <30, the pastes of the invention have good USDA paste color scores at 8.5 Brix. e.g. from 35-50, especially 42 or greater.

The homozygous rin plants may be made by at least two methods. The first utilizes a traditional breeding program. Of the several standard breeding methods, the backcross method is the most direct. A tomato line carrying the rin gene, such as LA3012, can be obtained from the C. M. Rick Tomato Genetics Resource Center at UC Davis or from another source and crossed with a commercially desirable cultivar such as FM6203, which can be obtained from Lockhart Seed Co. of Stockton, Calif. or numerous other seed dealers. Other appropriate open pollinated varieties would include Hunt 100 and UC82b. Multiple backcrosses to the recurrent parent (the commercial line) and selection of the rin phenotype would be conducted to recover the commercial cuitivar with the rin gene. After the final backcross (BC6), the tomato line would be selfed and the homozygous rin selected. Likewise, the preferred rinrin tomatoes homozygous for color enhancing genes can be prepared by breeding with FM6203.

Alternatively, the rinrin tomato can be obtained via plant transformation. In this method, the rin gene is cloned from a rin tomato line such as LA3012 and introduced into a desirable cultivar using transformation via tissue culture. Methods for transferring foreign DNA into plant cells include use of Agrobacterium tumefaciens as a vector, direct DNA uptake, e.g. facilitated by polyethylene glycol or electroporation, and microinjection of DNA into cells with a particle gun. Fertile plants are regenerated from the culture and these plants transmit the transferred gene to the next generation. If the transferred gene controls a recessive trait, selfing is necessary to make the gene homozygous, displaying the expected trait.

Plants heterozygous in both rin and nor can be obtained by crossing plants heterozygous in rin with plants heterozygous in nor.

The tomato homozygous in the rin gene and heterozygous or homozygous in the color enhancing gene can be obtained by using the transformed rinrin tomato as a starting point and either breeding or transforming the plant to include the color enhancing gene(s). Similarly, if desired, the rinrin tomato may be formed by breeding and the color enhancing gene introduced therein by transformation.

Although the use of homozygous color enhancing genes of the same type are preferred, it is also possible that tomatoes heterozygous in more than one type of color enhancing gene can be used.

The use of homozygous rin and/or nor genes is preferred. However, it is also possible that a tomato heterozygous in both the rin and the nor genes or homozygous in one of the rin or nor genes and heterozygous in the other may be used.

In accordance with the invention, various types of foods products can be prepared from the homozygous rin and/or nor tomatoes or heterozygous rin/nor tomatoes. For instance, red spaghetti sauce can be prepared. In general, red sauces, such as spaghetti sauces, will often satisfy the following parameters

12 to 25 Brix

4-13 cm Bostwick

1-2% salt

pH 4.0 to 4.4

As a result of the unique qualities of the tomatoes and paste mentioned above, a sauce having outstanding quality can be prepared in accordance with the invention.

Among the types of sauces which can advantageously be prepared in accordance with the invention include, but are not limited to, red spaghetti sauce, other red pasta sauces, pesto sauce, salsa, tomato puree, pizza sauce, tomato sauce, BBQ sauce, catsup and soup.

### EXAMPLE 1

(Prophetic)

A tomato plant which is homozygous for the rin mutant is produced by the backcross method, Open pollinated variety FM6203 is crossed with LA 3012. FM6203 is emasculated and pollen from LA3012 is applied to the stigma of FM6203. (Alternatively, crosses could be performed using FM6203 as the pollen parent.) The resulting F1 is then crossed again with FM6203. The BC1 progeny which contain rin are determined by selfing the BC1 and examining the BC1F1 for the homozygous rin phenotype.

Alternatively rin carriers can be ascertained by observing the fruit of the BC1 for the heterozygous rin traits such as delayed ripening and increased firmness. Repeated backcrossing to FM6203 and selection for the rin phenotype results in the rin character becoming fixed in the resulting cultivar.

### EXAMPLE 2

An advanced processing tomato line homozygous for rin and also homozygous for the color enhancing gene old gold crimson was grown under typical field conditions in 50 ft. plots in California. Although fruit were delayed in ripening, ripe fruit were extremely firm with yellow external and red internal color. Approximately 100 pounds of fruit was harvested and processed using a bench scale hot break and tubular evaporator system (manufactured by Femco Co.). The rinrin tomato paste was concentrated to only 15.5° Brix due to the extreme viscosity of the puree. In contrast, paste of typical tomato cultivars is concentrated to 21-26° Brix using this equipment.

The data from the analysis of rinrin paste is given below. The paste attributes of the rinrin paste were compared with paste from a commercial tomato cultivar, (Bos 3155 which can be obtained from Lockhart Seed Co. of Stockton, Calif. or numerous other seed dealers) processed in the same manner and using the same equipment as the rinrin paste.

Comparison of rinrin and BOS 3155 Tomato Pastes

### SUMMARY AND CONCLUSIONS

1. rinrin paste is thicker than the Bos 3155 paste because of a combination of a more expanded particulate phase and a higher serum viscosity.

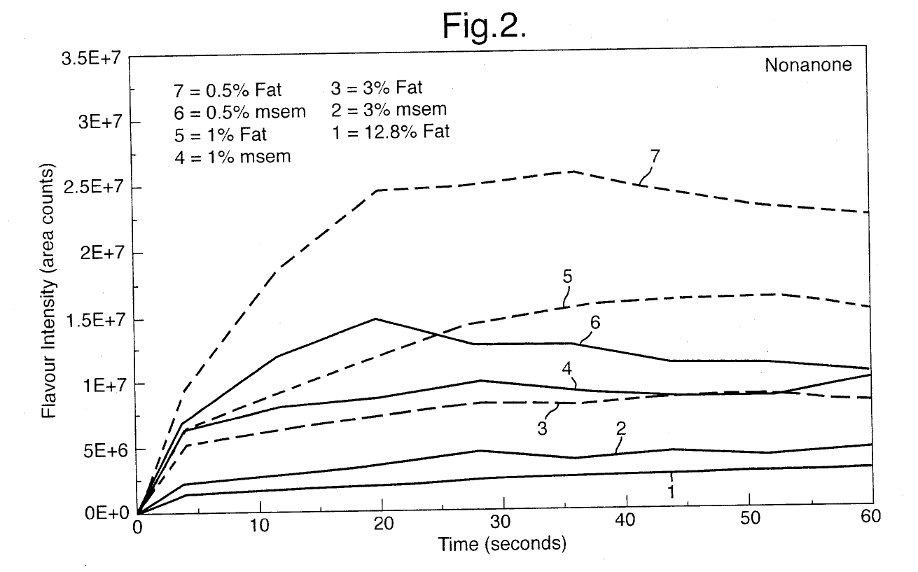

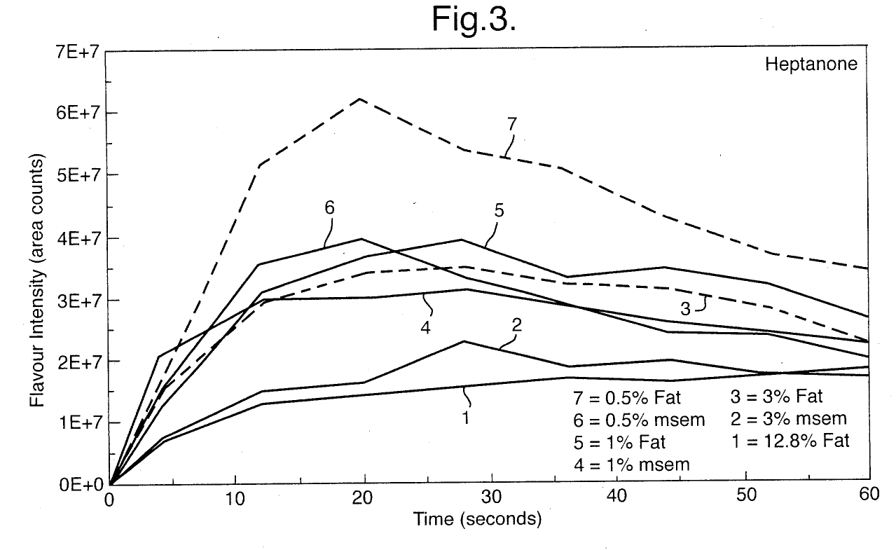

2. The more expanded particulate phase is deduced from the lower serum/pellet ratio of the rinrin, and is consistent with a lower concentration onset for significant thickening (FIGS. 2 and 3).

3. The viscosity of the serum phase of rinrin is very high (not only compared with Bos, which is relatively low, but also other pastes). This is probably the origin for the low blotter scores for rin and the high blotter scores for Bos 3155.

4. Two lines of evidence suggest that the Bos paste suffered more enzymatic damage to pectins than the rinrin. The 5% esterification of pectic galacturonic acid was high in rin and relatively low in Bos 3155. This suggests that PME (pectin methylesterase) has not acted significantly on rin but has on Bos 3155. Secondly pectic oligosaccharides are more abundant in Bos than in rin, consistent with the significant action of PG on the former but not the latter. The fruit was not analyzed, so it is not known how much of these changes were caused in the fruit, and how much is due to response to process.

Methods and Definitions

Brix measurements—These values reflect the content of soluble sugars in the serum fraction of paste by determination of refractive index. The measurements were made using a Bellingham and Stanley Ltd RFM 320 Refractometer, calibrated against distilled water. A sample of tomato paste was squeezed through filter paper and two or three drops of serum placed on the measurement surface of the refractometer. The value measured by the Refractometer was recorded.

Blotter tests—From each sample, 7 ml of pastes was aspirated into a plastic syringe and was carefully transferred into the central circle of a half-hour blotter test card (Bridge and Company, Chancery Lane, London). The test card was placed on top of an upright plastic beaker, and after half an hour the distance (in millimeters) migrated by the serum of the tomato paste was recorded along each of the four axes (North, South, East and West). Two blotter tests were carried out for each sample, and the four values were averaged. The larger the blotter value, the greater the level of syneresis present in the sample.

USDA paste color test—The color of a tomato concentrate was measured after dilution to 8.5 Brix, using the ColorQuest Instrument from Hunter. The a & b values obtained from a UCD/USDA hitched instrument are computed using the following equation.

Paste & Puree=−46.383+1.02411(a)+10.607(b)−0.42198(B)\hat{ }2 Color Score

Juice Color=29.600+0.88354(a)−1.8553(b)

USDA Color Classifications are as follows:

| | |
|---|---|
| Grade A | 45-50 points |
| Grade C | 40-44 points |
| Substandard | 0-39 points |

USDA grading of concentrate was done with equal weight given to color and absence of defects.

It should be noted that in addition to the tomato itself, color may be severely affected by thermal processing.

Serum:pellet ratios—these were determined by placing a weighed amount of each paste into a centrifuge tube, centrifuging at 5,000-10,000×g for 30 minutes, pouring off the serum, and recording the weights of the serum and the pellet. From these values the serum:pellet ratio can be calculated.

Serum viscosity—A Contraves Low Shear 30 Rheometer was used to measure the serum viscosity. A small amount of serum (approx 2 mls) prepared as for measuring serum:pellet ratios was placed in the cup-and-bob apparatus and a range of shear rates used to determine η° (viscosity at zero shear).

Small deformation rheology—A small amount of tomato paste mixture (approximately 3 g) was placed between parallel plates on a Rheometrics RDA2 (5 cm diameter, roughened by attachment of emery paper to plate surfaces to reduce slippage or surface friction phenomena). Frequency sweep measurements were made from 0.5-200 radian per second (rads¹), at 0.5% strain and at 30° C. G′ values were taken from the 10 rads¹ measurement. Time sweep measurements were made at 0.5% strain, 10 rads⁻¹ and 30° C. All samples were sealed with liquid paraffin to avoid desiccation or water exchange.

Dry Weight Estimates—samples of the pastes as delivered and from the dilution series for the concentration dependencies were placed into preweighed 10 ml glass vials. These were then weighed to enable the mass of the wet sample to be calculated. The vials were allowed to dry to constant weight at 60° C. under vacuum (in a benchtop vacuum oven). Dry weights of the vials were measured and used to calculate the % dry wt. of the original samples.

Total serum polymer—17.2076 g of rinrin paste equivalent to 3.132 dry weight and 14.2781 g of Bos 3155 paste equivalent to 3.6980 g dry weight, were washed extensively with MilliQ deionised water and all water washings collected after centrifugation at 2300 rpm on a benchtop centrifuge. The collected washing for each sample were dialyzed with 6 exchanges of MilliQ deionised water using a 14,000 cutoff dialysis membrane. The resultant solution was freeze dried and the polymers weighed and used for further analysis.

Cell wall preparation from juice—Cell wall was prepared after removal of serum with sequential water washes, by washing in absolute ethanol until white. The material was then hydrated with water to a dry weight of ˜5%.

Sugar composition of serum polymers and cell wall—5 mg of hydrated cell wall and 1 mg of serum polymers isolated as above were incubated in a solution of mannitol containing the cell wall degrading enzymes Viscozyme, Celluclast and Novozyme from Novo Nordisk (final concentration of 488 nmols per 250 uL). The mixture was left overnight at 45° C. and freeze dried. Once dry, the samples were hydrolyzed at 87° C. in teflon capped screwtop tubes with dry 2 Molar methanol/HCl prepared fresh. The samples were worked up by neutralizing with silver carbonate and addition of 2 drops of acetic anhydride. The methanol layer was decanted off and evaporated to give the methylglycosides. These were analyzed as the silyl ethers on a Carlo-erba Mega GC using the temperature program 150° C.-200 at 2° C. on a CPSIL 5CB 25M column. Results were calculated after subtraction of an enzyme blank.

Degree of esterification (% galacturonic ester)—Serum polymer isolated as above was redissolved in MilliQ deionised water at a concentration of 1 mg/ml. 15 ml of each solution was then titrated to pH 7 and the volume of titrant noted to reach equivalence. 100 units of pectin methyl esterase (from Sigma) was added and the solution autotitrated using a Metrohm 718 Stat Titrino at pH 7 until complete deesterification had occurred. The total volume of titrant added was noted and the percent ester calculated as follows:

(ml Total−ml acid/ml Total)*100

Oligosaccharide analysis by Dionex—Samples of serum obtained by washing the pastes with 3 volumes of MilliQ water were run on a Dionex HPLC system with amperometric detection. The solvent system used was a binary system and the gradient used is given in the table below:

| Time | % 100 mm NaOH | % 100 mm Sodium acetate |
|---|---|---|
| 0 | 100 | 0 |
| 30 | 60 | 40 |
| 35 | 0 | 100 |
| 40 | 0 | 100 |
| 45 | 100 | 0 |

The column used was a 50 cm Carbopac PA100. Samples were filtered through a 0.45 um PVDF Whatman filter before injection.

Bostwick: The Bostwick Consistometer is commercially available and comprises a stainless-steel, rectangular trough with two compartments separated by a spring-loaded gate. The sample compartment measures 5 cm.×5 cm.×3.8 cm. The larger of the troughs measures 24 cm. in length, 5 cm. in width and is etched with graduations every 0.5 centimeter. A clean, dry consistometer, maintained at 20 deg. C., is placed on a flat surface and a spirit level placed in the larger trough. Leveling screws are used to adjust the position of the device.

A sample of a diluted and temperature adjusted tomato concentrate is placed in the sample compartment and its surface leveled off with the flat side of a spatula. The gate locking lever is tripped and immediately a timer started. The sample is allowed to flow down the length of the trough, under its own weight for a fixed amount of time (usually 30 seconds). The distance the front edge of the fluid travels is estimated to the nearest 0.1 centimeter.

The United States Department Of Agriculture uses this method in grading tomato concentrates. The tomato concentrate is diluted to 12.0 NTSS as measured by a refractometer on a centrifugate of the sample. An amount of distilled water is added to 100 grams of tomato concentrate in a plastic bag, to achieve the 12.0 NTSS. The sample and water are “stomached” (mixed) to achieve the uniform distribution of the paste in the water. The NTSS of the resulting material is tested again to confirm it to be 12.0 NTSS and if indicated, adjusted to achieve the desired value. Once the sample is diluted its temperature is adjusted to 20 deg. C. and the test performed.

The Bostwick Consistency of a tomato concentrate is the number of centimeters the material flows under its own weight in thirty seconds.

Results

General appearance—Three teaspoons of each paste were placed onto a clean dish and their appearance was noted after 30 minutes and 1 hr 30 minutes.

30 minutes—The rinrin paste remained unchanged at 30 minutes. It still held shape and showed no signs of synersis (pooling). However the BOS 3155 control had slumped and spread a little with a ring of syneresed serum projecting around 2 mm from the central mass.

1 hr 30 minutes—The rinrin paste was much the same as at 30 minutes. The BOS 3155 control had spread and the ring of syneresis was projecting approximately 6 mm from the edge of the solid mass.

Bostwick and Blotter Ranges for rin, BOS 3155 and Other Tomatoes (tomatoes with high viscosity). These paste were processed on the benchtop evaporator described in Example 2.

| | Bostwick | Blotter |
|---|---|---|
| U373 | 3.1-4.7 | 4.5-15.25 |
| U370 | 3.4-4.0 | 10.0-16.75 |
| Asgrow 5210 | 3.5-5.4 | 11.0-18.25 |
| Antisense PG | 3.7-5.3 | 5.6-17.5 |
| BOS3155 | 4.5-6.1 | 13-22.5 |
| Homoz RIN | 0-2.0 | <2.5 |

The USDA paste color scores were 47.98 for the rinrin paste and 47.87-50.19 (ave. 49.33) for the Bos 3155 paste.

The samples as received in the can had the following characters:

| Sample | % Dry Weight | °Brix |
|---|---|---|
| RIN | 18.2% | 16.56 |
| BOS 3155 | 25.9% | 24.76 |

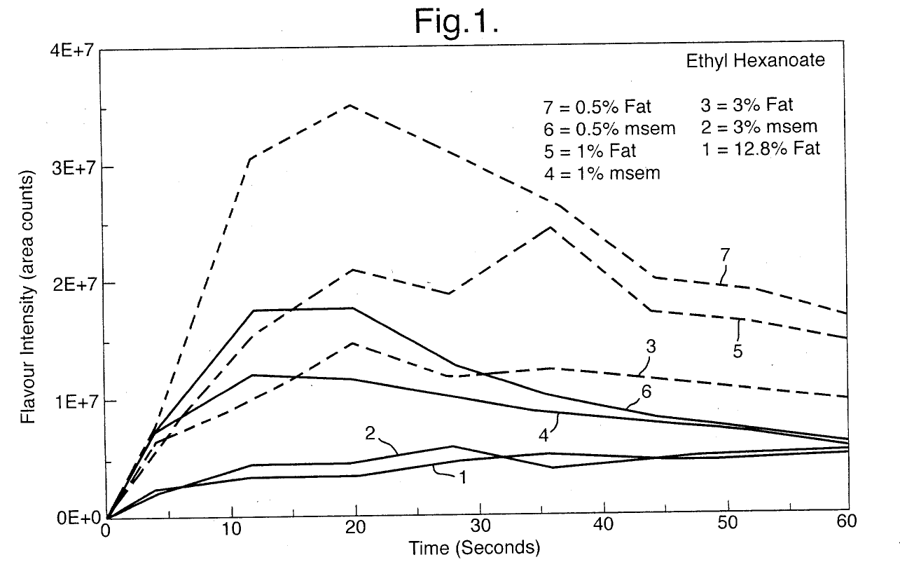

Ratio of soluble to insoluble solids—FIG. 1 shows a plot of the dry weight values vs. their respective °Brix for the samples used in the concentration dependence. As can be seen both the RIN and BOS 3155 pastes have the same slope and the same origin indicating that the ratio of insoluble to soluble solids are the same. With this information in mind it was possible to run the serum pellet ratios balanced for both solids and °Brix in one experimental set.

Concentration Dependencies—The concentration dependence behaviors of G′ (10 rads/s) for RIN and BOS 3155 pastes are given in FIG. 2. RIN appears to have a lower effective C₀ at 7.5% dry wt than BOS at 10% dry wt. The form of the concentration dependencies also shows that RIN solids are capable of generating greater structure on a weight for weight basis than the BOS 3155 control. Because the °Brix to dry wt ratios are the same for the two pastes, plotting °Brix against G′ gives a very similar concentration behavior, as seen in FIG. 3.

Serum/Pellet Ratios at 12°Brix:

The results for serum/pellet ratios were as follows:

| Replicate | Serum (g) | Pellet (g) | s/p ratio |
|---|---|---|---|
| RIN | | | |
| 1 | 13.16 | 9.06 | 1.45 |
| 2 | 14.79 | 9.7 | 1.52 |
| 3 | 13.45 | 9.33 | 1.44 |
| BOS 3155 | | | |
| 1 | 15.5 | 8.21 | 1.88 |
| 2 | 14.88 | 7.54 | 1.97 |
| 3 | 15.52 | 8.02 | 1.93 |

Averaged values - RIN = 1.47
BOS 3155 = 1.93

Blotters—Run on 12°Brix paste

RIN Paste

| Rep. | Time | North | South | East | West | Avg. |
|---|---|---|---|---|---|---|
| 1 | 10 min | 0 | 0 | 0 | 0 | 0 |
| | 20 min | 2 | 1 | 1 | 1 | 1.3 |
| | 30 min | 3 | 2 | 2 | 1 | 2 |
| 2 | 10 min | 0 | 0 | 0 | 0 | 0 |
| | 20 min | 1 | 1 | 0 | 1 | 0.75 |
| | 30 min | 2 | 2 | 1 | 1 | 1.5 |

BOS 3155 paste

| Rep. | Time | North | South | East | West | Avg. |
|---|---|---|---|---|---|---|
| 1 | 10 min | 3 | 4 | 5 | 4 | 3 |
| | 20 min | 10 | 8 | 7 | 8 | 8.25 |
| | 30 min | 11 | 12 | 11 | 10 | 11 |
| 2 | 10 min | 4 | 4 | 4 | 4 | 4 |
| | 20 min | 8 | 8 | 7 | 7 | 7.5 |
| | 30 min | 10 | 10 | 9 | 9 | 9.5 |

Serum results

| | η₀ values at | Polymer weight | Percentage |
|---|---|---|---|
| | 20° C. | (mg/g dry | galacturonic |
| | (mPas) | weight paste) | acid esterified |
| RIN | 38.25 | 64.6 | 73 |
| BOS 3155 | 4.81 | 64.2 | 40 |

Sugar analysis results

| | Rin | | 3155 | 3155 cell |
|---|---|---|---|---|
| Sugar | serum | Rin cell wall | serum | wall |
| ararabinose | 3 | 3 | 4 | 2 |
| rhamnose | 4 | 3 | 8 | 1 |
| xylose | 1 | 11 | 1 | 10 |
| mannose | 3 | 6 | 4 | 7 |
| Galactose | 6 | 6 | 4 | 5 |
| Galacturonic | 80 | 23 | 76 | 9 |
| Acid | | | | |
| Glucose | 3 | 49 | 2 | 65 |

Dionex Results

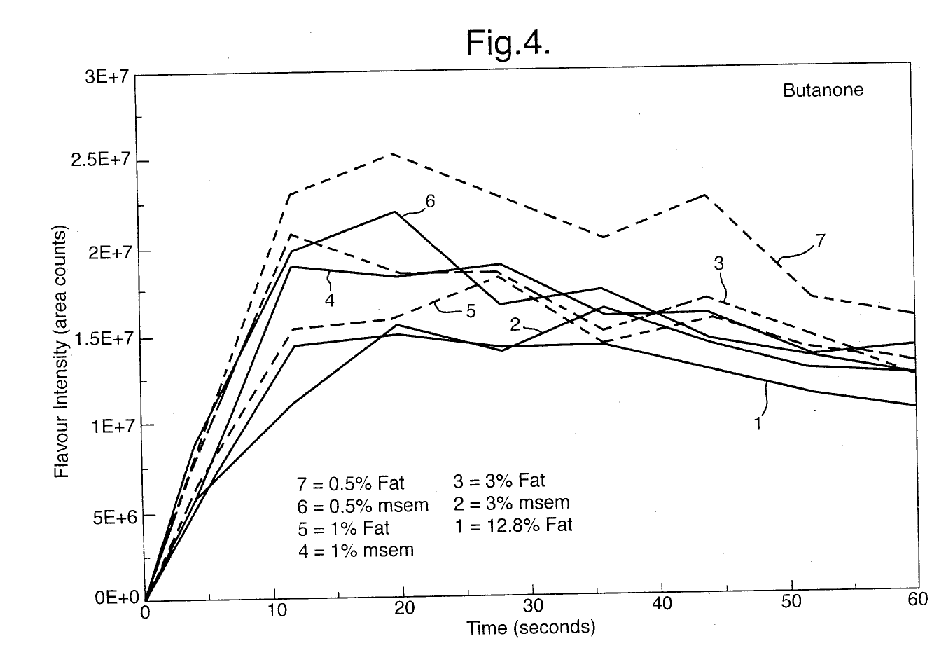

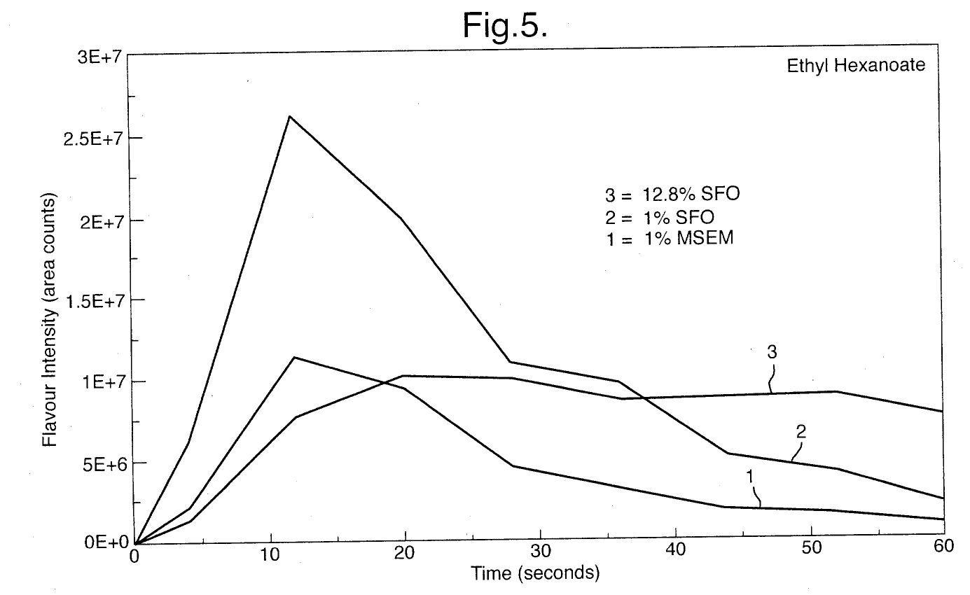

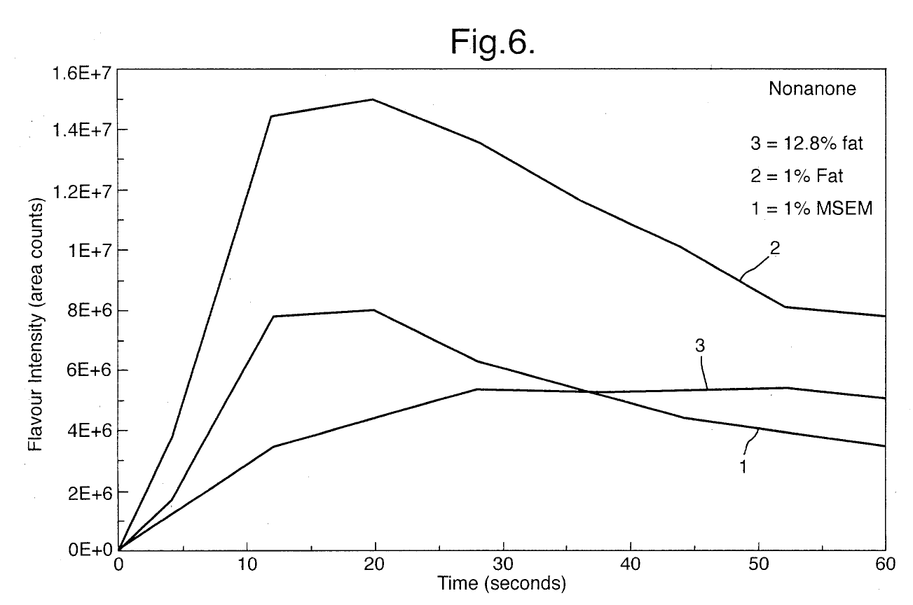

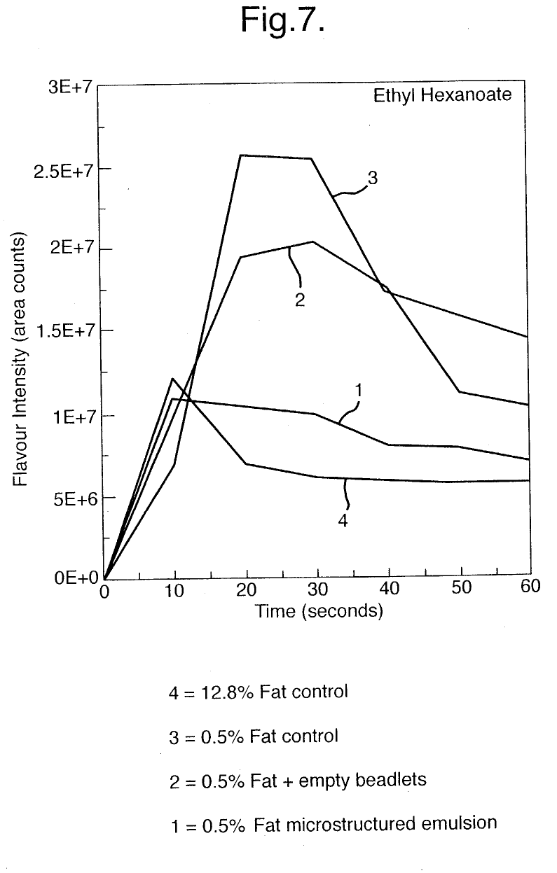

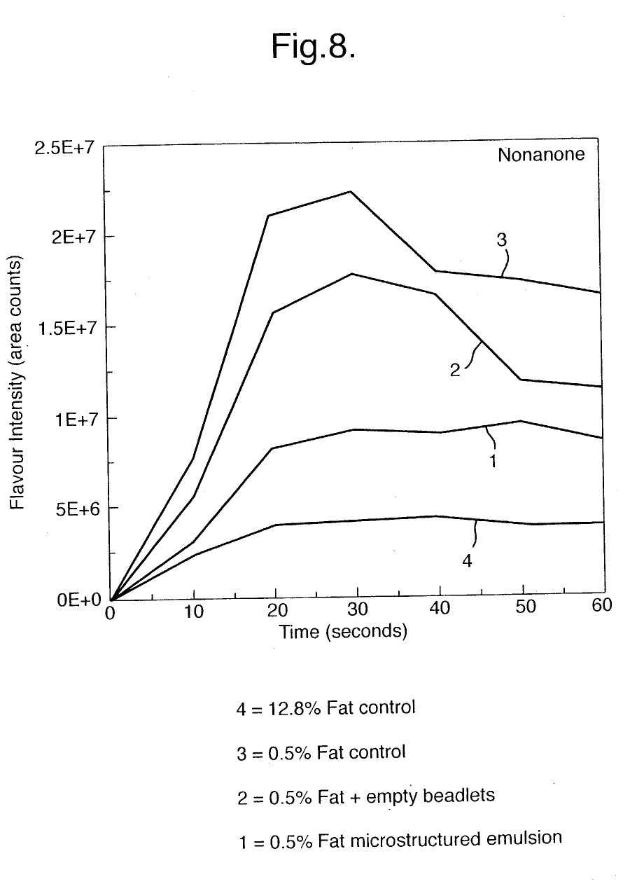

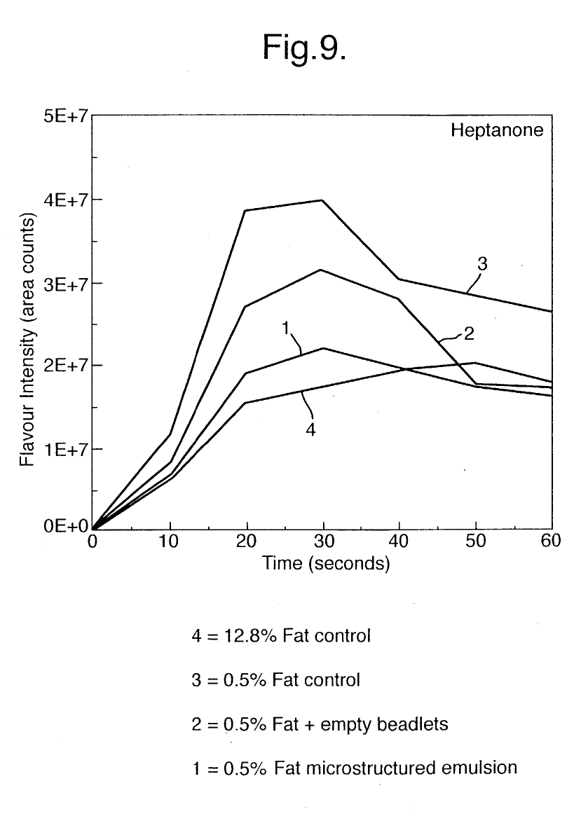

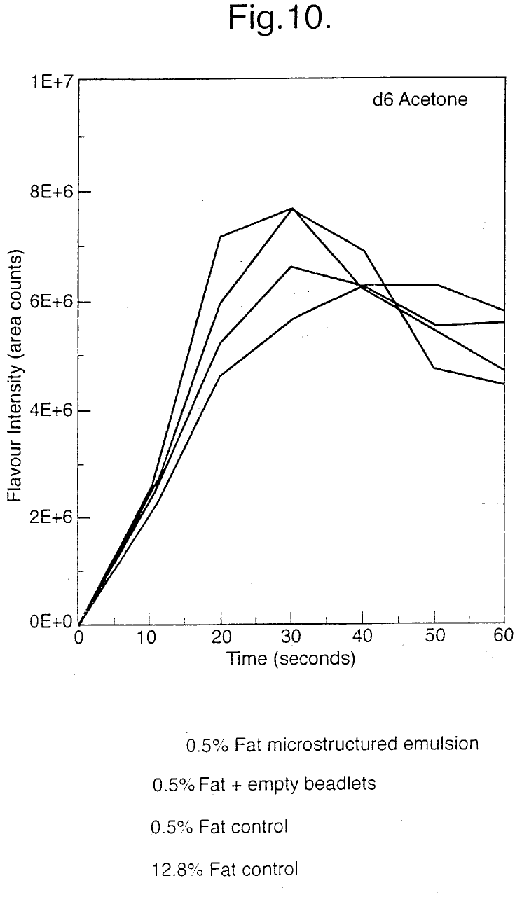

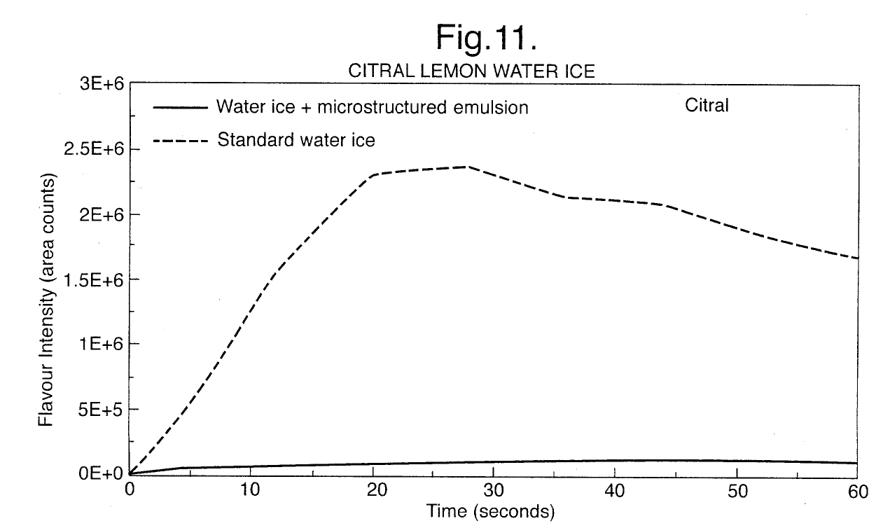

These results, shown graphically in FIG. 4, were unquantified as no standards were available. However, qualitatively there were differences in the amounts of pectic oligomers produced between the two paste serums. The RIN cross had qualitatively fewer pectic oligomers caused by pectin breakdown either during processing or through natural fruit ripening.

Overall, the data establish that pastes according to the invention have quite good viscosity together with good color.

### EXAMPLE 3

(Prophetic)

A spaghetti sauce is prepared in accordance with the invention using a puree made solely from rinrin tomatoes. A standard, conventional spaghetti sauce made from tomatoes other than rinrin tomatoes is also prepared. The sauces are prepared by mxing together the ingredients, heating and stirring.

Spaghetti Sauce Formulas

| | STANDARD | RIN |
|---|---|---|
| | PUREE | PUREE |
| INGREDIENT | PERCENT | PERCENT |
| WATER | 33.300 | 65.300 |
| TOMATO PUREE @ 15.5 BRIX | 64.000 | 32.000 |
| SOYBEAN SALAD OIL | 1.000 | 1.000 |
| SALT, ROCK | 1.000 | 1.000 |
| ONIONS | 0.500 | 0.500 |
| SPICES | 0.200 | 0.200 |

The sauce according to the invention made from rin paste has excellent quality, in particular, improved viscosity and syneresis compared to the conventional sauce. Moreover, the sauce of the invention includes substantially more large pectin chains. In addition, a secondary benefit is the fact that less puree needs to be used in the sauce of the invention as compared to the standard sauce.

Tomatoes in accordance with the invention fall within the genus Lycopersicon and preferably, though not necessarily, within the species Lycopersicon esculentum.

Preferably the pastes of the invention are made from essentially the same tomato plants. That is, the pastes of the invention preferably achieve the desired attributes of color and viscosity without resort to substantial amounts of tomato fruits which are not either a) homozygous for the rin and/or nor genes or b) heterozygous for both rin and nor genes. Preferably the paste is made from at least 90%, more preferably at least 95% of tomatoes and most preferably at least 99 wt % of tomatoes which are either a) homozygous for the rin and/or nor genes or b) heterozygous for both rin and nor genes. It is especially preferred that the paste comprises at least 90%, more preferably at least 95% of tomatoes and most preferably at least 99 wt % of tomatoes which are i) either homozygous or heterozygous, preferably homozygous, in at least one non-native color enhancing gene and ii) either a) homozygous for the rin and/or nor genes and/or b) heterozygous for both rin and nor genes.

All percentages herein are by weight unless stated otherwise or otherwise required by context.

It should be understood, of course, the specific forms of the invention herein illustrated and described are intended to be representative only as certain changes may be made therein without departing from the clear teachings of the disclosure. For instance, other ways of improving the color of tomatoes which are homozygous in rin and/or nor or which are heterozygous in rin and nor may occur to those skilled in the art. These may include breeding of the rin or nor tomatoes with certain tomatoes having desirable color attributes.

Reference should be made to the following appended claims in determining the full scope of the invention.

What is claimed is:

1. A tomato paste comprising tomatoes having homozygous mutant rin genes, homozygous mutant nor genes or tomatoes heterozygous in both rin and nor genes.

2. The tomato paste according to claim 1 which is homozygous in both mutant rin and mutant nor genes.

3. The paste according to claim 1 having USDA paste color scores at 8.5 Brix of from 35-50.

4. The paste according to claim 3 having USDA paste color scores of 42 or greater.

5. The paste according to claim 1 comprising at least 50% by weight tomatoes having homozygous mutant rin genes, homozygous mutant nor genes or tomatoes heterozygous in both rin and nor genes.

6. The tomato paste according to claim 1 wherein said tomatoes further comprise a color enhancing gene.

7. The paste according to claim 6 wherein said color enhancing genes are selected from the group consisting of old gold crimson, high pigment, dark green, intense pigment and color enhancing transgenic genes.

8. The paste according to claim 7 wherein said paste comprises at least 50 wt % of said tomatoes.

9. The paste of claim 5 wherein at least 50% of the tomatoes used to make the paste have homozygous mutant rin genes, homozygous mutant nor genes or are heterozygous in both rin and nor genes.

10. The paste of claim 8 wherein at least 50% of the tomatoes used to make the paste have homozygous mutant rin genes, homozygous mutant nor genes or are heterozygous in both rin and nor genes.

11. A sauce comprising tomatoes having homozygous mutant rin genes, homozygous mutant nor genes or tomatoes heterozygous in both rin and nor genes.

12. The sauce according to claim 11 having 12 to 25 Brix and 4-13 cm Bostwick.

13. The sauce according to claim 12 comprising from 0.5 to 2 wt % salt and a pH of from 4.0 to 4.4.

14. The sauce according to claim 13 wherein the salt level is from 1 to 2 wt %.

15. The sauce according to claim 11 which is selected from the group consisting of red spaghetti sauce, other red pasta sauces, pesto sauce, salsa, tomato puree, pizza sauce, tomato sauce, BBQ sauce, catsup and soup.

16. The sauce according to claim 15 wherein said sauce is a red spaghetti sauce.
